(19) United States
(12) Patent Application Publication
(10) Pub. No.: US 2013/0262007 A1
(43) Pub. Date: Oct. 3, 2013

(54) METHOD AND SYSTEM TO COMPUTE EFFICIENCY OF AN AUTOMATION INFRASTRUCTURE OF A PLANT

(71) Applicant: YOKOGAWA ELECTRIC CORPORATION, Tokyo (JP)

(72) Inventor: Naveen Kashyap, Bangalore (IN)

(73) Assignee: YOKOGAWA ELECTRIC CORPORATION, Tokyo (JP)

(21) Appl. No.: 13/838,847

(22) Filed: Mar. 15, 2013

(30) Foreign Application Priority Data
Mar. 28, 2012 (IN) 1195/CHE/2012

(51) Int. Cl. G06F 17/00

(52) U.S. Cl. CPC G06F 17/00
USPC 702/82

(57) ABSTRACT

The method and systems of the embodiments proposes to calculate Effectiveness of the Automation infrastructure of the plant by monitoring the control loop information using 3 primary data perspectives like availability, conformity and efficiency, by acquiring all data from the Distributed Control Systems (DCS)/Process Control Systems (PCS).

### TECHNICAL FIELD

Embodiments of the present disclosure relates to industrial automating technology. More particularly, embodiments relate to a method and a system to compute overall automation effectiveness for a process plant.

### BACKGROUND

Process Plants use automation solutions to ensure that the measurement & control systems are continuously available for functioning, to reduce human intervention and enhance the efficiency of resources & improve utilization and to maintain conformance to safe practices, targets & eliminate inconsistencies.

Many methods exist to measure operational efficiency, production efficiency etc. However in the operation life cycle of a plant, there are no specific quantifiable measurements which can measure whether these ‘automation’ objectives are met.

Hence, there exists a need to develop a system and a method to measure overall automation effectiveness using various information available from the Distributed Control Systems (DCS).

### SUMMARY

The shortcomings of the prior art are overcome through the provision of a method and a system as described in the description.

The present disclosure discloses a method to compute efficiency of an automation infrastructure of a plant. The method comprises collecting one or more engineering data and one or more process data from one or more data providers and prioritizing the collected one or more engineering data. Now, percentage of one or more predefined quality parameters is computed using the one or more prioritized engineering data and the one or more process data of each control loop by performing computation of one or more weights associated to each of the one or more prioritized engineering data based on severity category and also performing aggregation of the one or more process data. Now, the aggregated process data is compared with predefined threshold value to prioritize the aggregated data. At this stage, the computed one or more weights associated to each of the prioritized engineering data is combined with the prioritized aggregated process data to compute the percentage of one or more predefined quality parameters. At last, the computed percentage associated to each of the predefined quality parameters is processed to compute efficiency of the automation infrastructure of the plant.

A system to compute efficiency of an automation infrastructure of a plant is disclosed as another aspect of the present disclosure. The system comprises one or more data provider units and an efficiency computing engine. The one or more data provider units of the system provide one or more engineering data and one or more process data. An efficiency computing engine comprises a loop weights computing engine, an aggregator engine and a percentage computing engine. The loop weights computing engine is configured to compute one or more loop weights associated to each of the engineering data, wherein the engineering data is prioritized. The aggregator engine is configured for aggregating the one or more process data and prioritizing each of the aggregated data to determine an associated aggregated value. And the percentage computing engine is configured to compute the percentage of one or more predefined quality parameters using the loop weights and aggregated value. The efficiency computing engine computes the efficiency of the automation infrastructure of the plant using computed percentage of one or more predefined quality parameters computed by the percentage computing engine.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The features of the present disclosure are set forth with particularity in the appended claims. The disclosure itself, together with further features and attended advantages, will become apparent from consideration of the following detailed description, taken in conjunction with the accompanying drawings. One or more embodiments of the present disclosure are now described, by way of example only, with reference to the accompanied drawings wherein like reference numerals represent like elements and in which:

FIG. 1 illustrates an exemplary system to compute efficiency of an automation infrastructure of a plant according to one embodiment of the present disclosure.

FIG. 2 illustrates exemplary logical steps to compute efficiency of a plant according to one embodiment of the present disclosure.

FIG. 3 shows comparison of aggregated process data with predefined threshold value to prioritize aggregated data according to one embodiment of the present disclosure.

FIG. 4 illustrates computation of percentage of predefined quality parameters efficiency using prioritized engineering data and prioritized aggregated process data according to an embodiment of the present disclosure.

FIG. 5 shows computation overall automation effectiveness for a process plant using computed percentage of predetermined quality parameter efficiency according to an embodiment of the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The present disclosure discloses a method to compute efficiency of an automation infrastructure of a plant. The method comprising acts of collecting one or more engineering data and one or more process data from one or more data providers and prioritizing the collected one or more engineering data. The one or more engineering data is prioritized from high severity weight (Wₕ) to low severity weight (W₁). One or more weights associated to each of the one or more prioritized engineering data based on severity category is computed. Now, the one or more process data are aggregated. The aggregation is performed based on at least one of time and count. Then, the aggregated process data is compared with predefined threshold value to prioritize the aggregated data from high severity bad actor to low severity bad actor. The severity category associated to both of the engineering data and process data are either automatically derived based on at least one of tag security level and priority settings or manually classified by a user.

Now, the percentage of one or more predefined quality parameters is computed using the one or more weights of the engineering data and the one or more process data of each control loop i.e. when Wₕ is multiplied with high severity bad actor and W₁ is multiplied with low severity bad actor and the multiplied products are combined to generate total number of bad actors, which is required to compute percentage of one or more predefined quality parameters. The one or more predefined quality parameters include but are not limited to availability, conformity, and efficiency. The computed percentage of each predefined quality parameters is utilized to compute efficiency of the automation infrastructure of the plant. The computation of efficiency of the automation infrastructure of the plant, the aggregation of one or more process data and comparison of aggregated value with the threshold value are performed periodically set by at least one of a timer and a scheduler.

Another embodiment of the present disclosure discloses a system to compute efficiency of an automation infrastructure of a plant comprising one or more data provider units and an efficiency computing engine. The data provider unit is connected to the efficiency computing engine over control network. The control network may comprise a public network e.g., the Internet, World Wide Web, etc. or private network e.g., local area network (LAN), etc. or combinations thereof e.g., a virtual private network, LAN connected to the Internet, etc. Furthermore, the network(s) (1105 and 1104) need not be a wired network only, and may comprise wireless network elements. The efficiency computing engine is associated with the Field Control Stations (FCS) of the plant. The Field Control Station (FCS) is a device that performs process control. It consists of various types of function blocks that execute control calculations and the input/output functions such as the process input/output and the software input/output. The data provider units are configured to provide one or more engineering data and one or more process data. The one or more data providers are Distributed Control Systems (DCS) and Process Control Systems (PCS). The efficiency computing engine comprising a loop weights computing engine, an aggregator engine and a percentage computing engine. The loop weights computing engine computes one or more loop weights associated to each of the engineering data, wherein the engineering data is prioritized. The aggregator engine is configured for aggregating the one or more process data and prioritizing each of the aggregated data to determine an associated aggregated value. And the percentage computing engine computes the percentage of one or more predefined quality parameters using the loop weights and aggregated value. The efficiency computing engine computes the efficiency of the automation infrastructure of the plant using computed percentage of one or more predefined quality parameters. The computed efficiency is either displayed on a display unit or stored in a storage unit.

A loop (measurement point, loop, control loop, tag are used interchangeably) is a fundamental unit of a plant and overall health or utilization or effectiveness of the plant can be calculated by aggregating the behaviour of such individual loop along different dimensions.

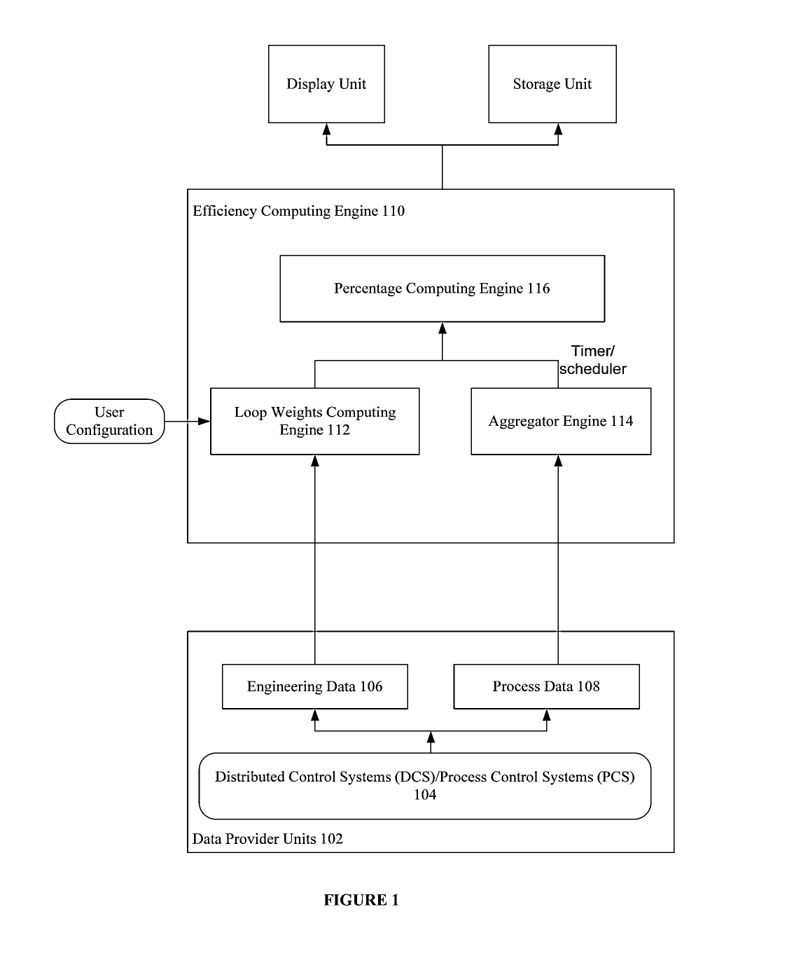

FIG. 1 illustrates a system to compute efficiency of an automation infrastructure of a plant according to one embodiment of the present disclosure. The system has Data Provider Units 102 and Efficiency Computing Engine 110. The Data Provider Units 102 comprises Distributed Control Systems (DCS)/Process Control Systems (PCS) 104 which provides Engineering Data 106 and Process Data 108. The data providers are set of interfaces required to fetch engineering and real time process data information for purpose of calculation.

The Efficiency Computing Engine 110 comprises Loop Weights Computing Engine 112, Aggregator Engine 114 and Percentage Computing Engine 116. The Efficiency Computing Engine 110 comprises of user configuration information to perform computation. The Loop Weights Computing Engine 112 which performs unique way of associating the effects of every given loop on the three dimensions of Overall Automation Effectiveness. The Loop Weights Computing Engine 112 computes weights associated to Engineering Data 106. The weights computed in Loop Weights Computing Engine 112 for each of the associated Engineering Data 106 can be also manually configured by a user. The Process Data 108 is aggregated in Aggregator Engine 114. The aggregation in Aggregator Engine 114 is periodically set by a timer or a scheduler. The results from Loop weights Computing Engine 112 and from Aggregator Engine 114 are processed to compute percentage associated to predefined quality parameters in Percentage Computing Engine 116. The efficiency computing engine 110 computes the efficiency of the automation infrastructure of the plant using results outputted from the Percentage Computing Engine 116.

The system further comprises a display unit to display the computed efficiency and a storage unit to store efficiency of the automation infrastructure of the plant. The computed efficiency can be displayed is different formats including but are not limited to spider web charts and other charts and reports in formats configurable by the user.

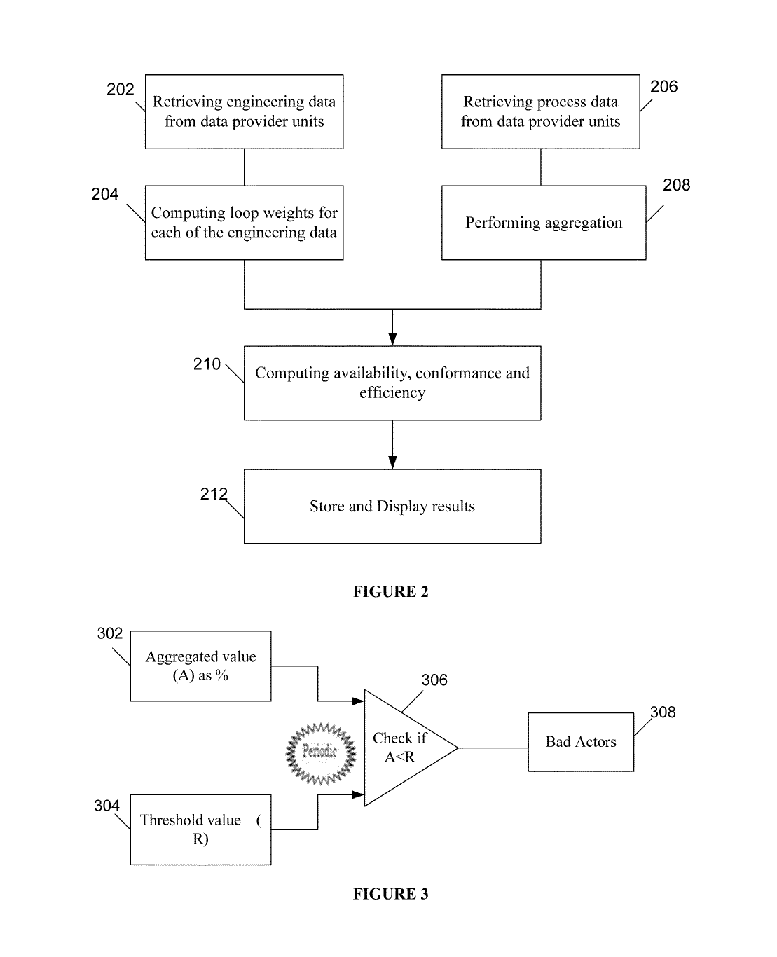

FIG. 2 illustrates a method to compute efficiency of a plant according to one embodiment of the present disclosure. At step 202, the Engineering Data 106 is retrieved from DCS/PCS 104. Weights associated to each of the Engineering Data 106 are computed at step 204. At step 206, the Process Data 108 is retrieved from DCS/PCS 104 and is aggregated at step 208. The percentage associated to each of the predefined quality parameters comprising availability, conformity and efficiency are computed. The efficiency of the automation infrastructure of the plant is computed using the percentage of the each of the predefined quality parameters. The efficiency computed is either stored and/or displayed.

The weights of each of the Engineering Data 106 are computed by the Loop Weights Computing Engine 112 when the Engineering Data 106 is prioritized from high severity to low severity priorities. The methodology of weight calculations are shown herein:

Total No. quality parameters=No. of High Severity priorities+No of Low Severity Priorities (1)

Weight for High Severity priorities (Wₕ)=(Total No. quality parameters−No. of High Severity priorities)/(No. of High Severity Priorities) (2)

Weight for Low Severity priorities (W₁)=(Total No. quality parameters−No of Low Severity priorities)/(No. of Low Severity Priorities) (3)

Now, from above three equations i.e. (1), (2) and (3) below equations holds good:

Wₕ=1/W₁ & W₁=1/WₕWₕ×W₁=1.

Each engineering data 106 is assigned a weight corresponding to its severity category. The severity category can be either automatically derived based on tag security level or priority settings or as manually classified by the user, during configuration. A floor & ceiling value for the max percentage composition of each category in the total number of loops can be applied during configuration (E.g. Not more than 15% of the total loops and not less than 2% of the total no. of loops can be of “High” Severity).

The one or more process data 108 are aggregated and value associated to the aggregated data is identified. This aggregation is performed over time to derive the average behaviour of the predefined quality parameters over a period of time, like but not limited to
a. The time interval for which the measurement point was ‘in-service’
b. The time interval for which the measured value was within safe (alarm) limits
c. The count of number of times for which a measurement point needed operator intervention (e.g. alarm acknowledge, adjustments etc)

This aggregation is performed periodically as sequenced by the timer or scheduler illustrated in FIG. 1. The logic followed for aggregation & comparisons are specific to the predefined quality parameters comprising Availability, Conformance & Efficiency calculations. The underlying logic is an arithmetic comparison of the snapshot value against a respective threshold entered by the user (default of 100%) that is performed periodically and results aggregated over a span of time including but is not limiting to g. Hour, Shift, and Day.

FIG. 3 shows comparison of aggregated process data with threshold value, which varies depending on the process, plant or unit configuration, to prioritize aggregated data according to one embodiment of the present disclosure. The comparison of the aggregated value with the threshold value is performed to identify the bad actors associated to each of the process data 108 as illustrated in FIG. 3. The aggregator engine 114 performs comparison logic. The aggregated value 302 (A) is compared with the respective threshold value 304 (R) at step 306. When the aggregate value (A) at step 302 is less than the threshold value (R) at step 304 over a given period of time (hour, day, shift, etc) the process data 108 associated to each of the quality parameters is identified as a bad actor 308. In other words, when the process data 108 associated to quality parameters performs in the required zone for less than the stipulated time (e.g. 22 hours over a 24 hour period, while the acceptance limit is 23 hours), it is listed as a bad actor 308.

Bad Actors 308 for each of the different quality parameters including but is not limiting to Availability, Conformance and Efficiency are identified based on below conditions and configuration of engineering data 106 and process data 108:

Bad Actors for Availability:

This is a measure of serviceability of the engineering data 106, process data 108 and control systems (DCS/PCS). It calculates the amount of time for which the loop was ‘in-service’ i.e. fully functional and providing indications or control of the process, for which they are engineered. In other words, the amount of time for which a measurement remains in an unreliable/unserviced state like input/output etc may be used as a criterion for identifying bad actors for Availability which is one of the predefined quality parameters. For example, a flow meter continued to measure and indicates the flow information to the DCS, a control valve received and acted on the control commands issued by the user, etc. . In automation terms, it is a measure of the amount of time a measurement point or tag is NOT in Input/Output Open State, Downstream failed state, Calibration state etc.

The bad actors 308 are those measurement points that consistently (Exceed the % duration specified by Availability Threshold) under perform with respect to Serviceability (Meaning that the measurement points are in ‘offline’ state/unreliable state for a time longer than permitted).

An example to compute the percentage of the comparison for availability is illustrated below:

% Aggregate Comparison=(Time for which the process data was ‘In Service’)/(Total Time of Monitoring)×100 (4)

The equation (4) is performed for different quality parameters and the results are forwarded to the efficiency computing engine 110 for computing efficiency of the automation infrastructure of the plant.

Bad Actors for Conformance:

This is a measure of accuracy of the system to follow the requests of the operator to continuously produce products which are on-spec or super spec. Researches in the field of loop performance indicate that the quality of the final product is affected by the standard deviation/variability/loop oscillation etc. This measure is applied only to closed loops of the control process (E.g. Closed Loop PID controller). The values needed for decision making are mostly available either directly or indirectly from the process control system.

Bad actors are those control loops which continue to operate outside the desired band of control, (deviation higher than limits), loop oscillation etc. More states or conditions than just deviation can be used to compute this metric as long as detection mechanisms are available.

Bad Actors for Efficiency:

Efficiency is a measure of capability of the control system to service the production requests with least possible manual intervention. This dimension measures the effort spent by the personnel in controlling the loop or control system to service the production requests. Repeated Alarms & Manual operations of the loops may indicate too much of human action, defeating the purpose of automation (A state of over automation).

Typical bad actor identifiers of this dimension would be time spent in alarm, time spent in limits (high/low limit clamping), No of manual operations exceeding an average target (e.g., say 2 per hour per measurement). These individual lists are then combined to derive the overall % Efficiency of the plant.

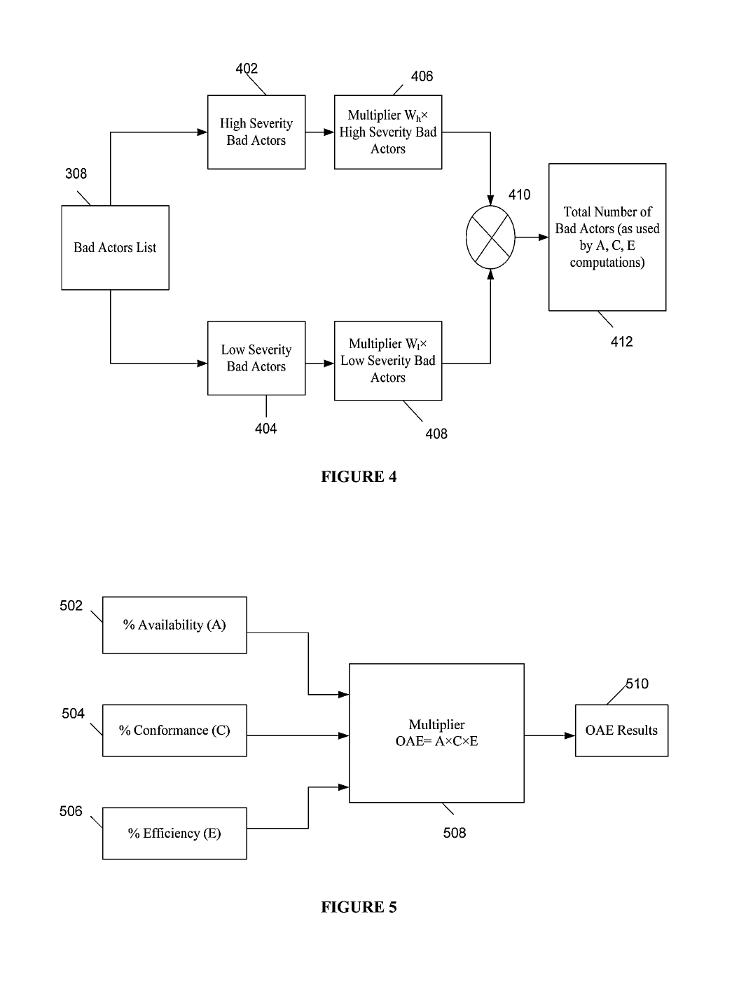

FIG. 4 illustrates computation of percentage of predefined quality parameters according to an embodiment of the present disclosure. The bad actors 308 along each quality parameter are identified as explained above. The overall list of bad actors 308 for each of these parameters is prioritized from high severity bad actor 402 to low severity bad actor 404. The high severity bad actors 402 are then multiplied by the corresponding weightage (Wₕ) for high severity tags at step 406 as calculated in equation 2. Similarly, the low severity bad actors 404 are then multiplied by the corresponding weightage (W₁) for low severity tags at step 408 as calculated in equation 3. The resulting outcome from steps 406 & 408 in FIG. 4 are summed up to derive the total number of bad actors 412 to be used which is required to compute percentage of one or more predefined quality parameters.

The equation now becomes—

Total Bad Actors=[W₁X(No of bad actors with low priority)]+[WₕX(no of bad actors with High priority)] (5)

(Where Wₕ & W₁ are calculated as per equation (2) & Equation (3))

When the bad actors are identified only for one parameter for the dimensions

% A (or % C or % E)=[(Total no. of loops−Total Bad Actors)/(Total no of loops)]×100 (6)

Where % A, % C and % E is percentage of Availability, Conformance and Efficiency respectively.

When each dimension is summarized based on multiple bad actor lists, the following equation will apply.

% A (or % C or % E)=[1−{ΣBad Actor_{i(i=1 to n})/(Total No of Loops×n)}]×100 (7)

Where n is the number of bad actor lists associated with each dimension & Bad Actor (i=1 to n) is the number calculated as per equation (5).

FIG. 5 shows computation of efficiency of the automation infrastructure of the plant according to an embodiment of the present disclosure. The % Availability 502, % Conformance 504 & % Efficiency 506 as derived using equation (7) are all input to the multiplier 508 to compute efficiency of the automation infrastructure of the plant (OAE) 510.

OAE (%)=Availability (A)%×Conformance(C)%×Efficiency (E)% (8)

The results may be recorded to be presented on graphic user interfaces or reports as configured by the user.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference | |
|---|---|
| Number | Description |
| 102 | Data Provider Units |
| 104 | Distributed Control Systems |
| | (DCS)/Process Control |
| | Systems (PCS) |
| 106 | Engineering Data |
| 108 | Process Data |
| 110 | Efficiency Computing Engine |
| 112 | Loop Weights Computing |
| | Engine |
| 114 | Aggregator Engine |
| 116 | Percentage Computing Engine |

1. A method to compute efficiency of an automation infrastructure of a plant, said method comprising acts of:
collecting one or more engineering data and one or more process data from one or more data providers and prioritizing the collected one or more engineering data;
computing percentage of one or more predefined quality parameters using the one or more prioritized engineering data and the one or more process data of each control loop by performing:
computing one or more weights associated to each of the one or more prioritized engineering data based on severity category; and
aggregating the one or more process data and comparing the aggregated process data with threshold value to prioritize the aggregated data; and
combining the computed one or more weights associated to each of the prioritized engineering data with the prioritized aggregated process data to compute the percentage of one or more predefined quality parameters; and
processing the computed percentage of each predefined quality parameters to compute efficiency of the automation infrastructure of the plant.

2. The method as claimed in claim 1, wherein the one or more predefined quality parameters is selected from at least one of availability, conformity, and efficiency.

3. The method as claimed in claim 1, wherein the one or more engineering data is prioritized from high severity weight (Wₕ) to low severity weight (W₁) and the aggregated process data is prioritized from high severity bad actor to low severity bad actor.

4. The method as claimed in claims 3, wherein the Wₕ is multiplied with high severity bad actor and W₁ is multiplied with low severity bad actor, wherein multiplied products are combined to generate total number of bad actors, which is required to compute percentage of one or more predefined quality parameters.

5. The method as claimed in claim 1, wherein the severity category is either automatically derived based on at least one of tag security level and priority settings or manually classified by a user.

6. The method as claimed in claim 1, wherein the computation of efficiency of the automation infrastructure of the plant, the aggregation of one or more process data and comparison of aggregated value with the threshold value are performed periodically set by at least one of a timer and a scheduler.

7. The method as claimed in claim 1, wherein the aggregation is performed based on at least one of time and count.

8. The method as claimed in claim 1, wherein the threshold varies depending on the process, plant or unit configuration.

9. A system to compute efficiency of an automation infrastructure of a plant comprising:
one or more data provider units to provide one or more engineering data and one or more process data;
an efficiency computing engine comprising:
a loop weights computing engine to compute one or more loop weights associated to each of the engineering data, wherein the engineering data is prioritized;
an aggregator engine configured for aggregating the one or more process data and comparing the one or more aggregated data with a threshold value for prioritizing each of the aggregated data in order to determine associated aggregated value; and
a percentage computing engine to compute the percentage of one or more predefined quality parameters using the loop weights and aggregated value;
wherein the efficiency computing engine computes the efficiency of the automation infrastructure of the plant using computed percentage of one or more predefined quality parameters.

10. The system as claimed in claim 8, wherein the one or more data providers is selected from at least one of distributed control systems and process control systems.

11. The system as claimed in claim 8 further comprises a display unit to display the computed efficiency and a storage unit to store efficiency of the automation infrastructure of the plant.
